(19) United States
(12) Patent Application Publication
(10) Pub. No.: US 2022/0387940 A1
(43) Pub. Date: Dec. 8, 2022

(54) GRAPHENE-POLYAMIDE COMPOSITE MEMBRANES AND MICROPARTICLES, METHODS OF MANUFACTURE, AND METHODS OF USE

(71) Applicant: University of Connecticut, Farmington, CT (US)

(72) Inventors: Douglas Adamson, Mansfield Center, CT (US); Chinthani D. Liyanage, Willimantic, CT (US)

(21) Appl. No.: 17/834,387

(22) Filed: Jun. 7, 2022

Related U.S. Application Data
(60) Provisional application No. 63/197,774, filed on Jun. 7, 2021.

(51) Int. Cl. B01D 71/02; B01D 71/56; C02F 1/469; C02F 1/467; C02F 1/28; B01J 20/20; B01J 20/26

(52) U.S. Cl. CPC B01D 71/021; B01D 71/56; C02F 1/469; C02F 1/4672; C02F 1/288; B01J 20/20; B01J 20/262; C02F 2103/08

(57) ABSTRACT

A composite that includes graphene and an interfacially-polymerized polyamide, where the composite is in the form of a self-supporting membrane having a graphene side opposite to a polyamide side, or the composite is in the form of a microparticle comprising a graphene core and a polyamide shell, a method of manufacture of the composites by interfacial polymerization and methods of use of the composite are described.

### CROSS-REFERENCE TO RELATED APPLICATION

This application claims priority to and the benefit of U.S. Provisional Application No. 63/197,774, filed Jun. 7, 2021, entitled “Electrochemical Membrane for Water Treatment and Redox Chemistry”, which is incorporated herein by reference in its entirety.

### STATEMENT OF GOVERNMENT SUPPORT

This invention was made with Government support under Grant No. DMR-1535412 awarded by the National Science Foundation. The Government has certain rights in the invention.

### FIELD AND BACKGROUND OF THE DISCLOSURE

Described herein are graphene-polyamide composites in the form of membranes and microparticles, their methods of manufacture, and uses thereof. The membranes are especially useful as electrochemical membranes, for example for water treatment and redox chemistry. The microparticles are especially useful for water treatment such as desalination.

Graphene is characterized by carbon atoms connected in sp² hybridization, closely packed into a single-layer two-dimensional honeycomb lattice structure. Due to its optical, electrical, and mechanical properties, graphene has been used in advanced materials for a variety of applications, such as in materials science, micro-nano processing, energy, biomedicine, drug delivery, and the like. Graphene polymer composites have been intensively studied for a variety of applications as well. For example, antiviral and antibacterial graphene-polyamide composites are described in CN113174129A, which discloses a nylon web impregnated with a combination of polyamide, epoxy, cellulose, nanosilver, a hydrogel, and graphene. Acknowledging the difficulty of forming graphene-polyamide composites by processes such as melt blending, KR101395843B1 discloses forming a composition by in-situ ring-opening polymerization of aliphatic lactam monomers in the presence of graphene derivatized with a lactam monomer. CN111909372A discloses in situ polymerization of polyamide monomers in the presence of a combination of graphene, Mxene, and carbon black to provide a material that can be spun into fibers. In still another approach, U.S. Pat. No. 10,456,754 discloses formation of a graphene-polyamide onto a support membrane.

There nonetheless remains a need in the art for methods for the manufacture of graphene-polyamide composites in a variety of forms such as membranes and microparticles. Such composite forms can be used in a variety of different applications.

### SUMMARY

Disclosed herein is composite, comprising graphene and an interfacially-polymerized polyamide, wherein the composite is in the form of a self-supporting membrane having a graphene side opposite to a polyamide side, or the composite is in the form of a microparticle comprising a graphene core and a polyamide shell.

A method of preparing the graphene-polyamide composite includes forming a biphasic polymerizable mixture comprising an aqueous solvent, an organic solvent immiscible with the aqueous solvent, graphene, a polymerizable monomer composition; and (a) to form the membrane, providing a single interface between the aqueous phase and the organic phase in the biphasic polymerizable mixture, and allowing the polymerizable monomers to polymerize under conditions effective to form the membrane at the interface; or (b) to form the microparticles, providing multiple interfaces between the aqueous phase and the organic phase in the biphasic polymerizable mixture; and allowing the polymerizable monomers to polymerize under conditions effective to provide the graphene-polyamide composite microparticles.

In another aspect, a method of water treatment includes providing the above-described graphene-polyamide composite membrane for filtration by flow-through mode, connecting the graphene-polyamide composite membrane to a current source, supplying an effective amount of current to the membrane, and passing water containing a source chemical for electrochemical oxidation and a solute for treatment over the membrane to obtain a filtrate separated from at least a portion of the solute for treatment.

In still another aspect, a method of desalinating water includes immersing the graphene-polyamide composite microparticles of any one of claims 1 to 4 in an aqueous saline solution, allowing the microparticles to selectively absorb water into their core and exclude one or more solutes, isolating the microparticles from the saline solution, and applying a pressure on the microparticles to release desalinated water.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 is a schematic diagram showing the assembly of a membrane in a flow-through cell set up (left panel), and the results of applying current on pH (right panel).

FIG. 2 is a graph illustrating the NaCl electrolysis performance of a graphene-polyamide composite flow-through electrode membrane when applied external potential is ON or OFF.

FIG. 3 is a bar graph that illustrates the efficiency of methylene blue color removal by varying applied current density.

FIG. 4 shows scanning electron microscope (SEM) images of a graphene-polyamide composite membrane, wherein panel A shows the polymer surface of the membrane facing the heptane solution, panel B shows the graphene side of the membrane showing overlapping graphene flakes, and panels C and D are high magnification images of the polymer side showing structural nodules.

FIG. 5 shows photographs of purified graphene-polyamide composite membrane samples, where the top left sample shows the surface facing the heptane phase and the top right sample shows the surface facing the water phase during the interfacial polymerization; and the bottom images show a flexed membrane sample (left) and the sample after flexing (right) to illustrate the robustness of the membrane.

FIG. 6A is a schematic image of an embodiment of a process for synthesis of a graphene-polyamide composite membrane; and FIG. 6B is an SEM image exfoliated graphene formed at the water-heptane interface.

FIG. 7 shows atomic force microscopy (AFM) surface topology images where panel A is a control polyamide membrane; panel B is a graphene-polyamide composite polymer surface; panel C is a graphene-polyamide graphene surface; panel D is a graphene-polyamide membrane graphene surface; and panel E is a graph showing a comparison of the roughness (Rrms) of the control polyamide membrane and polymer surface, and graphene surface of the graphene-polyamide composite membranes. All images were flattened to ensure the curvature of the substrate would not affect the height measurement.

FIG. 8 shows graphs showing the electrical impedance of the graphene-polyamide composite membrane, where panel A shows the frequency dependence of the impedance (Bode plot) and panel B shows a Z′-Z″ Nyquist Plot showing two semicircles, RC circuit behavior, where the squares trace is from experimental data, and the solid line is from the simulation.

FIG. 9 shows graphs showing the results of nanoindentation testing on the graphene side of the membrane surface, where panel A is before electrochemical reactions and panel B is after electrochemical reactions.

FIG. 10 shows a Fourier transform infrared (FTIR) spectroscopy image of the polymer side of a graphene-polyamide composite, illustrating membrane stability and functional group analysis before and after electrochemical reaction of the membrane.

FIG. 11 is a schematic illustration of an embodiment of a method of preparation of graphene-polyamide microparticles using interfacial polymerization.

FIG. 12A is an optical microscope image of polyamide microparticles; and FIG. 12B is an SEM image of the polyamide shell of the microparticles showing a rigid valley structure.

FIG. 13 shows photographs of a graphene-polyamide microparticles illustrating the swelling (left panel) and shrinking (right panel) of a microparticle in response to an osmotic pressure difference.

### DETAILED DESCRIPTION

The inventors hereof have developed interfacial processes for the manufacture of graphene-polyamide composites in the form of a self-supporting membrane or a microparticle. The membranes have a graphene side and a polyamide side as further described below, and the microparticles have a graphene core and a polyamide shell, also as further described below. Because the membranes and microparticles are formed by interfacial polymerization, each of the graphene and polyamide side of the membrane, and each of the graphene core/polyamide shell are closely integrated, forming unitary structures having advantageous properties.

Accordingly, in an aspect, an advantageous composition and method to fabricate a self-supporting graphene-polyamide composite membrane are described. By “self-supporting” it is meant that the graphene-polyamide composite has structural integrity without use of a separate support membrane. As made, the composite membrane has a “polyamide side” or layer where polyamide predominates as the material, and which is integrally bonded to or incorporated with an opposite “graphene side” or layer where graphene predominates as the material. Accordingly, without being bound by theory, it is believed that this membrane construction, which arises from the interfacial method of manufacture described herein, results in the membrane being supported by the graphene in the composite, and could be described as a “graphene-supported” membrane. In a preferred aspect, the interfacial process described herein allows the fabrication of a polyamide layer on essentially pure graphene sheets to provide the graphene-polyamide composite. Thus, it is possible to obtain graphene sheets supported or embedded in polyamide surfaces where no further polymer binder or support is used in the graphene-polyamide composite membrane. In a further advantage, the self-supporting graphene-polyamide composite membrane is flexible, rather than brittle.

In another aspect, an advantageous composition and method to fabricate graphene-polyamide composite microparticles via interfacial polymerization are described, where the microparticles have a graphene core and a polyamide shell disposed on the core. The term “shell” is used herein for convenience, and does not imply any particular hardness or other mechanical characteristics. The shell is preferably a polyamide membrane that allows the passage of water and a solute. The shell can partially or completely surround the core. In an embodiment, at least 80% of each core is surrounded by the shell, or at least 90% of each core is surrounded by the shell, or at least 95% of each core is surrounded by the shell, or at least 98% of each core is surrounded by the shell. The microparticles can be generally spherical, i.e., of perfect or imperfect spherical shapes, which includes oblate spheroids, ellipsoids, ovoids, and the like.

An interfacial method is used for the manufacture of both the composite membranes and the composite microparticles. Without being bound by theory, polymerization occurs at the interface towards the organic phase due to the solubility difference in each monomer in the water and organic phases, respectively yielding a membrane that has two sides or surfaces with distinct compositions. A polyamide is predominant on one surface towards the organic phase and graphene is predominant on the surface towards the aqueous phase of a graphene-polyamide composite membrane formed at a biphasic interface polymerization.

The polyamide of the composite is formed by interfacial polymerization of monomer composition, for example a lactam or a polyamine compound and a polycarbonyl compound reactive with the polyamine. The polyamine compound includes at least two amino groups, for example two, three, or four primary or secondary amino groups, or more. A combination of primary and secondary amine groups can be used, or all of the amine groups can be primary amine groups. In an aspect, the polyamine compound is a diamine having primary amine groups. The polycarbonyl compound reactive with the polyamine compound similarly includes at least two carbonyl groups reactive with a primary or secondary amine, for example two, three, or four carbonyl groups. Carbonyl groups reactive with amines include carboxylic acids or the corresponding salts thereof, aldehydes, isocyanates, and carbonyl halides, for example carbonyl chlorides, bromides, or iodides. A combination of different types of carbonyl groups can be used. A preferred polycarbonyl compound reactive with the polyamine compound is a tricarbonyl halide, for example a tricarbonyl chloride.

Suitable polymerizable monomers for the production of polyamides, such as lactams, polyamine compounds, and polycarbonyl compounds are known in the art, and can be aliphatic or aromatic, or a combination of aliphatic and aromatic compounds can be used. For example, the polymerizable monomers can be a lactam such as caprolactam.

Possible polyamine compounds that can be used include linear, branched, or cyclic aliphatic diamines, for example ethylenediamine, tetramethylenediamine, hexamethylenediamine, nonamethylenediamine, undecamethylenediamine, dodecamethylene diamine 1-butyl-1,2-ethanediamine, 1,1-dimethyl-1,4-butanediamine, 1-ethyl-1,4-butanediamine, 1,2-dimethyl-1,4-butanediamine, 1,3-dimethyl-1,4-butanediamine, 1,4-bis Methyl-1,4-butanediamine, 2,3-dimethyl-1,4-butanediamine, 2-methyl-1,5-pentanediamine, 3-methyl-1,5-pentanediamine, 2,2-dimethyl-1,6-hexane dicamber, 2,5-dimethyl-1,6-hexanediamine, 2,4-dimethyl-1 1,6-hexanediamine, 3,3-dimethyl-1,6-hexanediamine, 2,2,4-trimethyl-1,6-hexanediamine, 2,4,4-trimethyl-1,6-hexanediamine, 2,4-diethyl-1,6-hexanediamine, 2-methyl-1,7-heptanediamine, 2,2-dimethyl -1,7-heptanediamine, 2,3-dimethyl-1,7-heptanediamine, 2,4-dimethyl-1,7-heptanediamine, 2,5-dimethyl-1,7-heptanediamine, 2-methyl-1,8-octanediamine, 3-methyl-1,8-octanediamine, 4-methyl-1,8-octane alkanediamine, 1,4-dimethyl-1,8-octanediamine, 2,4-dimethyl-1,8-octanediamine, 3,4-dimethyl-1,8-octanediamine, 4,5-dimethyl-1,8-ctanediamine, 2,2-dimethyl-1,8-octanediamine, 3,3-dimethyl-1,8-octanediamine, 4,4-dimethyl-1, 8-octanediamine, cyclopropanediamine, cyclopropyldiaminomethyl, cyclobutyldiaminomethyl, cyclopentyldiaminomethyl, and bis (4-aminoyclohexyl) methane, bis(4-aminocyclohexyl)propane, 1,2-cyclohexanediamine, 1,3-cyclohexanediamine, 1,4-cyclohexanediamine, 1,3-bisaminomethylcyclohexane, 1,4-bisaminomethylcyclohexane; 1-amino-3-aminomethyl-3,5,5-trimethylcyclohexane, (5-amino-2,2,4-trimethyl-1-cyclopentanemethylamine, 5-amino-1,3,3-trimethylcyclohexanemethylamine, bis(4-amino-3-methylcyclohexyl) methane, bis(4-amino-3-methylcyclohexyl) propane, bis (4-amino-3-ethylcyclohexyl) methane, bis(4-amino-3,5-dimethylcyclohexyl) methane, bis (4-amino-3,5-dimethylcyclohexyl) propane, bis(4-amino-3-ethylcyclohexyl) methane, bis(4-amino-3-ethylcyclohexyl) propane, bis(4-amino-3,5-diethylcyclohexyl) methane, bis(4-amino-3,5-diethyl cyclohexyl) propane, bis(4-amino-3-methyl-5-ethylcyclohexyl) methane, bis(4-amino-3-methyl-5-ethylcyclohexyl) propane, or the like.

Other possible polyamine compounds that can be used include aromatic amines such as 5-methyl-1,9-nonanediamine; p-phenylenediamine, m-phenylenediamine, p-xylylenediamine, m-xylylenediamine, 2,4-toluenediamine, 2,6-toluenediamine, 1,4-diaminonaphthalene, 1,8-diaminonaphthalene, 2,3-diaminonaphthalene, 2,6-diaminenaphthalene, 3,3′-diaminodiphenylmethane, 3,4′-diaminodiphenylmethane, 4,4′-diaminodiphenylmethane, 4,4′-diamino-3,3′,-dimethyldiphenylmethane, 4,4′-diamino-3,3′-diethyldiphenylmethane, 4,4′-diamino-3,3′,5,5′-tetramethyldiphenylmethane, 4,4′-diamino-3,3′,5,5′-tetraethyldiphenylmethane, 4,4′-diamino-3,3′-dimethyl-5,5′-diethyldiphenylmethane, 2,2′-bis (3-aminophenyl) propane, 2,2′-bis (4-aminophenyl) Propane, 2,2′-bis (4-amino-3-methylphenyl) propane, 2,2′-bis (4-amino-3-ethylphenyl) propane, 2,2′-bis (4-amino-3,5-dimethylphenyl) propane, 2,2′-bis (4-amino-3,5-diethylphenyl) propane, bis (4-amino-3-methyl-5-ethylphenyl) propane, or the like. A functionalized amine such as a polyetherdiamine (e.g., a poly(oxyalkylene) ether or a poly(oxyalkylene-co-oxyalkylene ether), or the like can be used. A combination of different amines can be used to modify the properties of the polyamide, for example mechanical strength or flexibility.

Possible polycarbonyl compounds that can be used include straight chain or branched aliphatic compounds such as adipic acid, pimelic acid, suberic acid, azelaic acid, sebacic acid, undecanedioic acid, and dodecanedioic acid, tridecanedicarboxylic acid, triglutaric acid, tetradecanedioic acid, pentadecanoic acid, hexadecanedioic acid, octadecenedioic acid, eicosenedioic acid, dimethylmalonic acid, 3,3-dimethylsuccinic acid, 2,2-dimethylglutaric acid, 2-methyladipic acid, 3-methyladipic acid, trimethyl adipic acid, 2-butyl suberic acid, 2,3-dibutyl succinic acid, 8-ethyloctadecanoic acid, 8,13-dimethyl eicosanedioic acid, 2,2-octylundecanoic acid, 2-nonylsebacic acid, or the like; or aromatic compounds such as isophthalic acid, terephthalic acid, 1,4-naphthalenedicarboxylic acid, 1,8-naphthalenedicarboxylic acid 2,6-naphthalenedicarboxylic acid, 2,7-naphthalenedicarboxylic acid, 4,4′-diphthalic acid, diphenylmethane-2,4-dicarboxylic acid, diphenylmethane-3,4′-dicarboxylic acid, diphenylmethane-4,4′-dicarboxylic acid, or the like. The corresponding carbonyl halides of the foregoing acids can be used. A combination of different polycarbonyl compounds can be used to modify the properties of the polyamide, for example mechanical strength or flexibility.

In aspect, the monomer composition includes the polyamine compound and the polycarbonyl compound, both of which are aromatic, in that at least one aromatic group is present in each monomer, and an aromatic polyamide is formed. The aromatic group can monocyclic or polycyclic, fused or linked by a single bond or by group such as an oxygen, methylene, or the like. Examples of aromatic groups include phenyl, naphthyl, anthracenyl, phenanthrenyl, biphenyl, a triphenyl, fluorenyl, or the like. In an aspect the aromatic group is a phenyl group. A substituent can also be present on the aromatic group, provided that it does not significantly adversely affect the production or properties of the composites. Substituents that can be present include a halogen, cyano, nitro, C₁₋₆ alkyl, C₂₋₆ alkenyl, or C₂₋₆ alkynyl, for example. In an aspect, the polyamine compound is meta-phenylene diamine (MPD) and the polycarbonyl compound is 1,3,5-benzenetricarbonyl trichloride (TCI). Without being bound by theory, polymerization of these two monomers for a polyamide including units as shown in Scheme I.

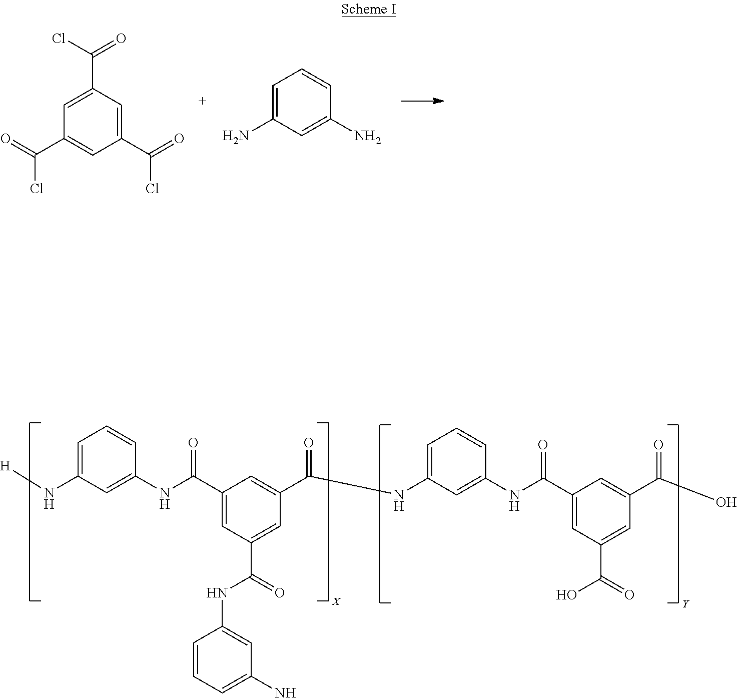

wherein X and Y are greater than 10, for example, and are determined by the reaction conditions as is known in the art. It is also possible for crosslinking to occur, for example between the amino group in the units denoted by X.

To carry out the interfacial method for the formation of the composite membranes or the composite microparticles, a biphasic polymerizable mixture is provided comprising an aqueous solvent, an organic solvent immiscible with the aqueous solvent, graphene, an optional metal salt, and a polymerizable monomer composition, for example the polyamine compound and the polycarbonyl compound reactive with the polyamine compound. Polymerization occurs at an interface of the aqueous phase and the organic phase of the biphasic polymerizable mixture. This polymerization incorporates the graphene also at the interface of the biphasic mixture. When the biphasic polymerizable mixture has a single interface between the aqueous phase and the organic phase, a membrane is formed. When the biphasic polymerizable mixture has multiple interfaces between the aqueous phase and the organic phase, for example when the biphasic mixture is in the form of an emulsion, microparticles are formed.

The aqueous solvent in the biphasic polymerizable mixture is preferably water. The organic solvent in the biphasic polymerizable mixture is immiscible with the aqueous solvent, such that the aqueous solvent and the organic solvent form two distinct phases. The organic solvent is also selected to dissolve the polycarbonyl compound. Suitable organic solvents include carbon tetrachloride, chloroform, cyclohexane, 1,2-dichloroethane, dichloromethane, diethyl ether, ethyl acetate, heptane, hexane, methyl-tert-butyl ether, pentane, toluene, 2,2,4-trimethylpentane, or the like. A combination of different organic solvents can be used.

The graphene in the biphasic polymerizable mixture is preferably exfoliated, and can be in particulate form, for example as flakes. Methods for the exfoliation of graphene are known in the art, and can include, for example, mechanical agitation in the aqueous phase. In an aspect, the graphite can exfoliate into graphene sheets as it spreads at the interface of a biphasic liquid mixture.

The optional metal salt, when used, can be an alkali metal salt, an alkaline earth metal, a main group metal salt, a transition metal salt, a lanthanide metal salt, or a combination thereof. The cation can be organic or inorganic, for example a C₁₋₁₆ carboxylate (e.g., an acetate), a halide, a nitrate, a nitrite, a phosphate, a sulfate, or the like. In an aspect, the metal salt is wholly inorganic. The inorganic metal salt can be, for example an alkali metal halide, an alkaline earth metal halide, or a combination thereof. The metal salt can be, for example, an alkali metal chloride such as lithium chloride or sodium chloride.

The salts can be present for a variety of purposes, for example to prepare more defect-free reverse osmosis membranes, as is known in the art. For example, for all the membranes prepared, 1 w/v % of lithium chloride salt, based on the volume of water in the biphasic polymerizable composition was present in to order to recover the composite membrane without defects. Other amounts can be used, such as 0.5 to 5 w/v %, and are readily determined by one of ordinary skill in the art. A salt is present during preparation of the composite microspheres, for example in the aqueous phase of the polymerizable monomer composition, to provide the resulting microparticles filled with salt in order to attract water into the microparticles by osmotic pressure. The metal salt can be, for example, sodium chloride. The amount of metal salt can be determined by one of ordinary skill in the art without undue experimentation, and can be, for example an amount of 1 to 25 w/v %, or 5 to 20 w/v %, or 5 to 15 w/v %, each based on the volume of water in the biphasic polymerizable composition.

The components of the biphasic polymerizable mixture can be combined in any order, provided that the desired single or multiple interfaces are obtained. For example, the polyamine compound (where used) and metal salt can be dissolved in the aqueous phase, and the graphene added, followed by the organic solvent with or without the lactam or polycarbonyl compound. Mixing followed by standing can provide a single interface. Where the organic solvent does not include the lactam or the polycarbonyl compound, it can be added to the biphasic mixture neat or with additional solvent. In a convenient process, before or after the organic solvent is added, graphite can be added to the aqueous solvent and exfoliated, preferably in the presence of the polyamine compound (where used) and the optional metal salt to provide the graphene. Ultrasonication can be used to enhance dispersion or exfoliation of the graphite or graphene.

Alternatively, an aqueous phase including the polyamine compound (where used) and the graphene can be emulsified in the presence of the organic solvent to provide droplets including the polyamine compound and the graphene in a continuous phase of the organic solvent. The lactam or polycarbonyl compound, neat or optionally with additional organic solvent is then added to the emulsion. Again, in a convenient process, graphite can be added to the aqueous solvent and exfoliated before emulsification, preferably in the presence of the polyamine compound (where used) and the optional metal salt to provide the graphene. Ultrasonication can be used to enhance dispersion or exfoliation of the graphite or graphene.

The relative amounts of each of the components in the polymerizable biphasic graphene mixture can be varied depending on factors such as solubility, processability, maintaining the desired interface, and polymerization conditions. In general, an excess molar amount of the polycarbonyl compound is used relative to the amount of polyamine. The polycarbonyl compound can be added at one time, or sequentially.

Polymerization at the single or multiple interfaces is allowed to proceed under conditions known to be effective, for example at room temperature over a period of 12 to 48 (or more) hours at atmospheric pressure. The conditions for polymerization can be varied as to temperature, time, and pressure, and concentration of components without undue experimentation.

In an aspect, a graphene-polyamide composite membrane develops at the solvent interphase bearing heterogeneous structures due to local fluctuations of temperature and concentration, with the formation of nanobubbles, and differences in diamine diffusivity. In different aspects, the concentration of the monomers for polymerization and temperatures at the solvent interphase can be adjusted by adjusting of rate of addition of a monomer to the mixture, molar ratio variation and addition or removal of solvent of higher or lower temperature to vary the microstructure of a composite membrane structure. Such structures can play an important role in water permeability, solute rejection, and mechanical strength of a graphene-polyamide composite.

The composite membranes or composite microparticles can then be separated from the biphasic polymerization mixture and any side products. For example, the membrane can be lifted and washed, for example with deionized water, or the particles can be filtered or centrifuged followed by decanting the liquid phases.

The relative weight percentages of graphene and polyamide in the composite membranes or composite microparticles can be varied by varying the size and amount of the graphene particles and the polymerization conditions used, such as the reactivity of the monomers and the time used for polymerization. For example, the composite membranes or composite microparticles can comprise 10 to 90 weight percent of the graphene and 10 to 90 weight percent of the polyamide, or 20 to 80 weight percent of the graphene and 20 to 80 weight percent of the polyamide, or 30 to 70 weight percent of the graphene and 30 to 70 weight percent of the polyamide, each based on the total weight of the composite, and where the percents total 100.

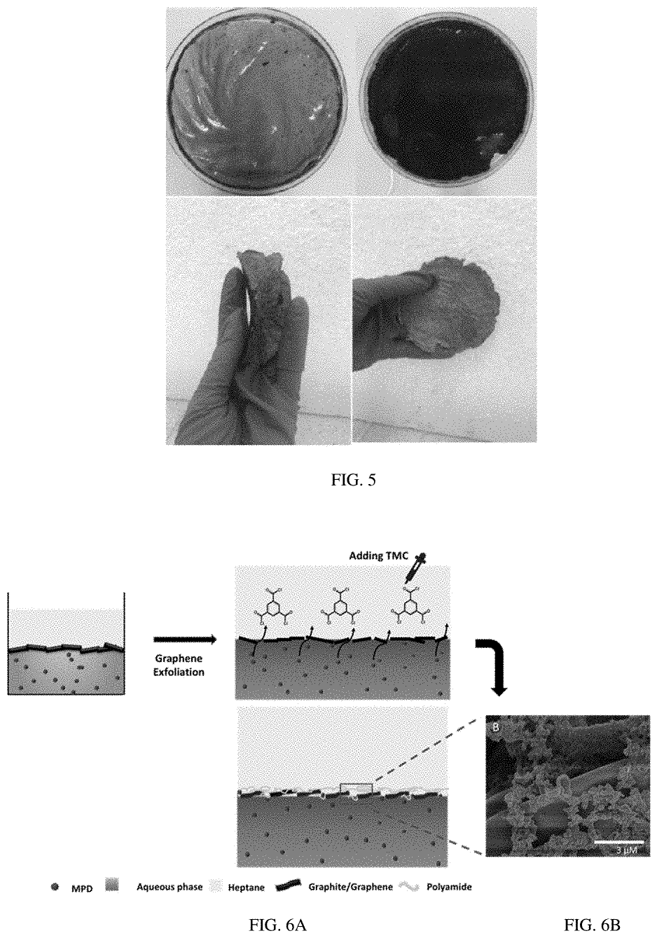

The total thickness of the composite membrane can further be varied by varying the size and amount of the graphene particles in the polymerizable composition, and the polymerization conditions used, such as the particular reactivity of the monomers and the time used for polymerization. For example, the composite membrane can have an average thickness in cross-section from 10 to 5000 micrometers, or from 100 to 4000 micrometers, or from 200 to 3000 micrometers, or from 500 to 2000 micrometers, or from 500 to 1000 micrometers. As stated above, the composite membranes can be flexible and mechanically robust, as shown in the two bottom panels of FIG. 5, where the left panel shows flexing of the membrane and the right panel shows the membrane after being flexed.

The size of the composite microparticles can be varied by varying the size and amount of the graphene particles in the polymerizable composition, the degree of dispersion of the graphene, the size of the emulsified droplets, and the polymerization conditions used, such as the particular reactivity of the monomers and the time used for polymerization. For example, the composite microparticles can have an average largest diameter of 0.5 to 1000 micrometers, or 0.5 to 800 micrometers, or 1 to 800 micrometers, or 5 to 500 micrometers. The largest average diameter can be determined, for example, by measuring the largest diameter of a sample, for example by scanning electron microscopy, and determining the average. The thickness of the shell can further be varied by adjusting the polymerization conditions used to form the microparticles, for example the time the polymerization is allowed to proceed and/or the concentration of the monomers used.

The graphene-polyamide composite membranes can be electrically conductive, and as such, can have a variety of uses. Without being bound by theory, the graphene-polyamide composite membrane has a network of graphene sheets directly connected. Such network sheets are in close contact, and electrons can hop between sheets creating a percolating network, providing electrical conductivity. In another aspect, a graphene sheet is not in direct contact with another sheet, but instead has a polymer separating it, and the sheets can be treated as electrodes possessing a polymer matrix in between, creating a microscale capacitor. The capacitor points can allow charge carriers or electrons to accumulate at the interface of the electrode. The overall conductivity of such a system can drop due to the presence of an imperfect interface. The interface effect known as Maxwell-Wagner-Sillar (MWS) polarization describes conductivity mismatch between two adjacent materials and influences polarization and charge accumulation. In an aspect, imperfect interfaces between graphene sheets can form numerous nano capacitors in nanocomposites of a graphene-polyamide composite membrane.

The graphene sheets in the graphene-polyamide composite membrane can act as electrodes and/or an array of electrodes for an electrochemical oxidation reaction. In an embodiment, an array of more than one composite membrane electrode pairs can be used, for example to perform electrochemical reactions. The electrode spacing can be in the range of nanometers. As such, the spacing can enable an increased mass transfer rate between electrodes. Also, the electrode can have a high surface area, which can allow for an increased rate of electron transfer reactions. In an embodiment, the array is a simplified two electrode system.

The graphene-polyamide composite membrane can be a thin film membrane for electrochemical water decontamination. In an aspect, the electrochemical oxidation on a graphene-polyamide composite membrane can be direct or indirect. Direct oxidation involves destroying contaminants adsorbed on a membrane surface by electron transfer reactions. Indirect electrochemical oxidation is achieved through the in-situ generation of strong oxidants such as hydroxyl radicals and hypochlorite/chlorine, enabling the non-selective degradation of organic contaminants. For example, chloride ions are abundant in natural water and wastewater effluents, and hypochlorite generation is more economical. For example, the chloride ions can be oxidized to active chlorine species such as Cl. (radicals), free chlorine (HOCl, OCl⁻), or the like, Thus, in an aspect, the graphene-polyamide composite membrane can be used for in-situ generation of strong oxidizing products for removing contaminants in wastewater, to enable water treatment exemplified by textile dye removal, removal of residual pharmaceuticals or their byproducts, or for mitigation of fouling.

The composite membranes can be in the form of a flow-through electrode membrane to perform the electrochemical reactions, for example, in water purification, such as for the removal of a chemical or bacteria. Thus, composite membranes can be used to perform industrial, chemical, or other wastewater purification, including, for example, water reclamation and reuse, desalination, brackish water treatment, and industrial separations. The purification can be in an industrial setting or in water purification facilities. Accordingly a method of water treatment can include providing the graphene-polyamide composite membrane of for filtration by flow-through mode, connecting the graphene-polyamide composite membrane to a current source, supplying an effective amount of current to the membrane, and passing water containing a source chemical for electrochemical oxidation and a solute for treatment over the membrane to obtain a filtrate separated from at least a portion of the solute (e.g, a contaminating chemical such as a dye, a mixture of chemicals, or a bacteria) for treatment. The source chemical for electrochemical oxidation can be, for example, sodium chloride. In various aspects at least 30% of the solute is separated, or at least 50% of the solute is separated, or at least 70% of the solute is separated, or at least 80% of the solute is separated, or at least 90% of the solute is separated.

Because the energy consumptions are significantly lower than in conventional purification methods, and the removal can be highly efficient (for example, up to about 90% efficient), the composite membranes can be of particular utility in desalination or the removal of pollutants in large-scale water purification and disinfection facilities. The composite membranes can also be lower cost to manufacture and operate over conventional purification methods. In still another advantage, the membranes can have good aqueous transport and lower membrane fouling properties.

In another aspect, the graphene-polyamide composite microparticles can be used in a desalination process. In particular, a method of desalinating water includes immersing the graphene-polyamide composite microparticles in an aqueous saline solution, allowing the microparticles to selectively absorb water into their core and exclude one or more solutes, isolating the microparticles from the saline solution, and applying a pressure on the microparticles to release desalinated water. Optionally, the microparticles are washed before a pressure is exerted on them to release desalinated water.

This disclosure is further illustrated by the following Examples, which are not intended to limit the claims.

### EXAMPLES

All materials were generally used as received. The graphite used in the Examples were in flake form, having an average lateral dimension of average of 3 μm.

### Example 1. Graphene-Polyamide Membranes

### Synthesis of Graphene-Polyamide Membrane

An aqueous solution of 2 w/v % m-phenylenediamine (MPD) and 1 w/v % lithium in water was prepared. To a wide glass jar, 70 milliliters (ml) of the aqueous solution and 30 ml of heptane were added, followed by 10 mg of graphite. This mixture was shaken for 2 minutes, then allowed to rest undisturbed for about 15 minutes, to provide a layer of exfoliated graphene at the water and oil interface. The heptane layer was siphoned off without disturbing the graphene at the interface, and a fresh portion of heptane was added along the wall of the glass jar to provide a heptane layer. A solution of 0.1 w/v % 1,3,5-benzenetricarbony trichloride (TMC) was then added along the wall of the glass jar and the system was maintained undisturbed overnight at room temperature. The resultant graphene-polyamide composite membrane was recovered and purified using deionized (DI) water.

A control polyamide membrane was made without adding graphite, using the same procedure and monomer content, where the system was allowed to stand undisturbed for two days at room temperature to polymerize. The resultant polyamide membrane was recovered and purified using DI water.

### Membrane Testing

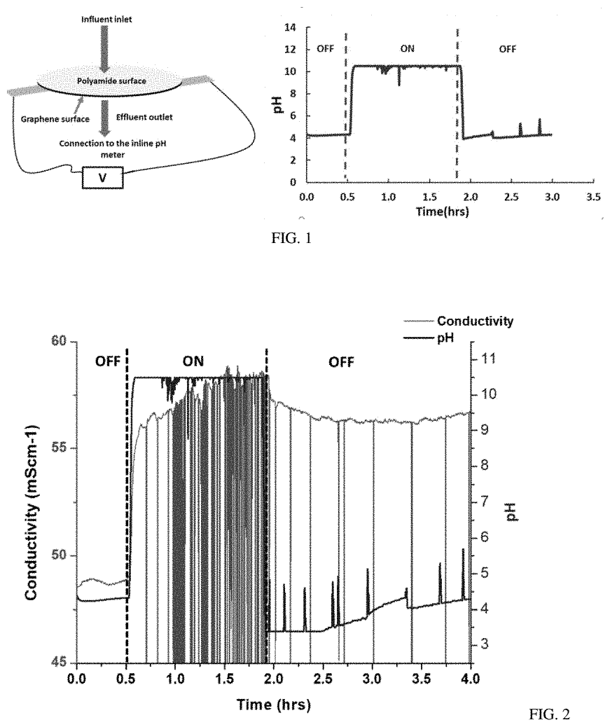

The graphene-polyamide composite membrane was sealed inside a custom-made flow cell and connected to a DC power supply as shown schematically in FIG. 1, left panel. The membrane was sealed using an O-ring to provide effective membrane area of 10.1 square centimeters (cm²). A platinum metal plate was placed in contact with the membrane and connected to a DC power supply (Keithley 2640). An electrolyte solution of 0.5 M NaCl was pushed through the membrane using a syringe pump at a rate of 0.3 ml/min. The solution passing through the membrane was connected to an inline pH meter probe to monitor changes in real time. The results are shown in FIG. 1, right panel. When the membrane was electrified, the pH effluent solution reached 10.4, indicating the formation of alkaline products. The vertical lines were recorded in pH plots indicating air bubbles flowing through the sensor, implying the vigorous formation of gas.

A conductivity probe was further placed in the flow cell and the membrane was electrified. Conductivity and pH results over time is when applied external potential is ON or OFF are shown in FIG. 2. The change in pH implies the formation of basic electrolysis products and the change in ionic conductivity indicates the formation of new chemical species.

### Contaminant Dye Removal

A sample of a graphene-polyamide composite membrane was saturated with 100 μM methylene blue (MB) solution prior to testing. For testing, a solution of 100 μM of MB in 0.5 M NaCl was used as the effluent, and 1-6 V DC potential was applied across the membrane. The system was allowed to equilibrate at each applied voltage before collecting the effluent aliquot. The amount of MB in each aliquot was measured using a UV-VIS spectrophotometer at the λ max of 665 nm. The current density was calculated by measuring current flow through the membrane at each applied voltage.

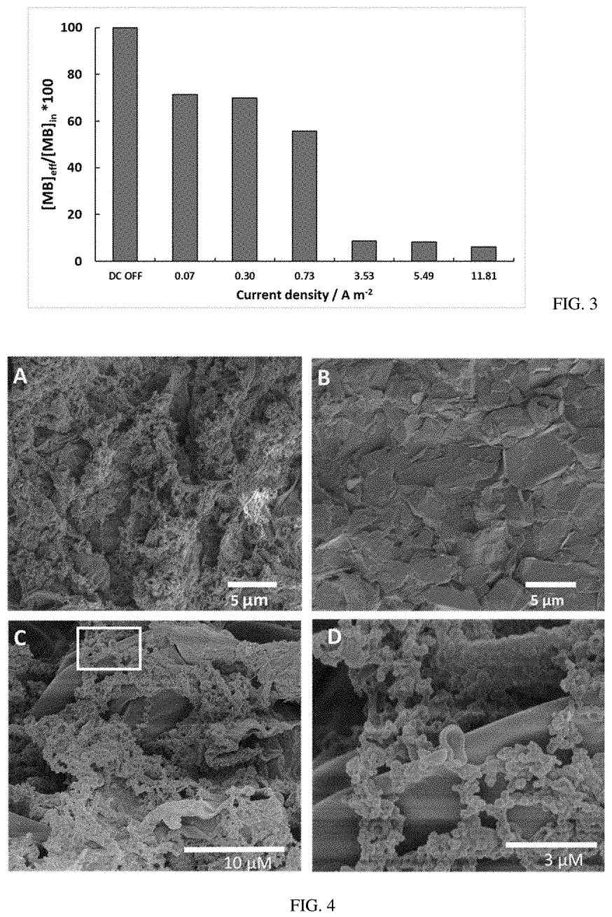

The percent of MB remaining in collected aliquots with respect to the incident MB solution at each current density is shown in FIG. 3. Percent of MB removal significantly increased from 44% to 91% at an applied current density from 0.7 to 3.5 A m⁻². Thereafter at 5.5 and 11.8 A m⁻², dye removal efficiency reported as 92 and 94% respectively. When the voltage in applied current density is 5 to 6V, the dye removal percentage increased from 92% to 94%, a 2% increment.

Electric energy consumption of contaminant oxidation can be evaluated in terms of electric energy per order (EO), which represents the amount of electric energy required to reduce the contaminant by one order of magnitude. For a flow-through process, EO can be defined as

EO=UI/F log(Cf/Cp),
where U is the applied cell potential,
I is current,
F is the flow rate, and
Cf and Cp are the contaminant concentration in feed and permeate solution, respectively.

EO can be considered a representative figure of merit for the determination of energy consumption in electrical energy-driven processes. The energy consumption is increased with the increasing applied potential. However, in the experiment, the percent of MB removal did not show significant increment (2%), indicating increasing side reactions. The EO rose from 0.8 to 3.5 KWh/m³ when the applied current density increased from 3.5 to 11.8 Am⁻². Therefore, considering high percentage dye removal and relatively low energy consumption, 3.5 Am⁻² (4V) is preferred.

### Membrane Characterization

FIG. 4 shows scanning electron microscope (SEM) images of a graphene-polyamide composite membrane. Panel A of FIG. 4 shows the polyamide surface of the membrane (the surface developed facing the heptane solution). Panel B of FIG. 4 shows the graphene side of the membrane (the surface developed facing water at the interface), showing overlapping graphene flakes. Panels C and D show structural nodules of the polyamide surface, where panel D is a higher magnification image of the square shown in panel C.

FIG. 5 shows photographs of isolated and washed graphene-polyamide composite membrane samples, where the top left sample shows the polyamide surface facing the heptane phase and the top right sample shows the graphene surface facing the water phase during the interfacial polymerization. The bottom images show a flexed membrane sample (left) and the sample after flexing (right), which illustrates the robustness of the composite membranes.

To further observe surface microstructures, graphene-polyamide composite membranes were imaged by atomic force microscopy ((AFM), Asylum Research MFP-3D). Samples were air-dried and mounted on glass slides with double-sided tape. Imaging was performed in tapping mode using silicon tips (Asylum Probes, AC-160). Spring constant of 26 N/m, tip radius of 7 nm, resonance frequency of 300 kHz). Scans sizes between 2×2 μm and 10×10 μm were acquired at line rates of 1 Hz, with a typical setpoint and feedback gain settings optimized for surface tracking. Scanning electron microscopy ((SEM) images were captured on an FEI Nova SEM 450). The wet membranes were wiped and mounted onto SEM stubs and allowed a vacuum to dry before the imaging.

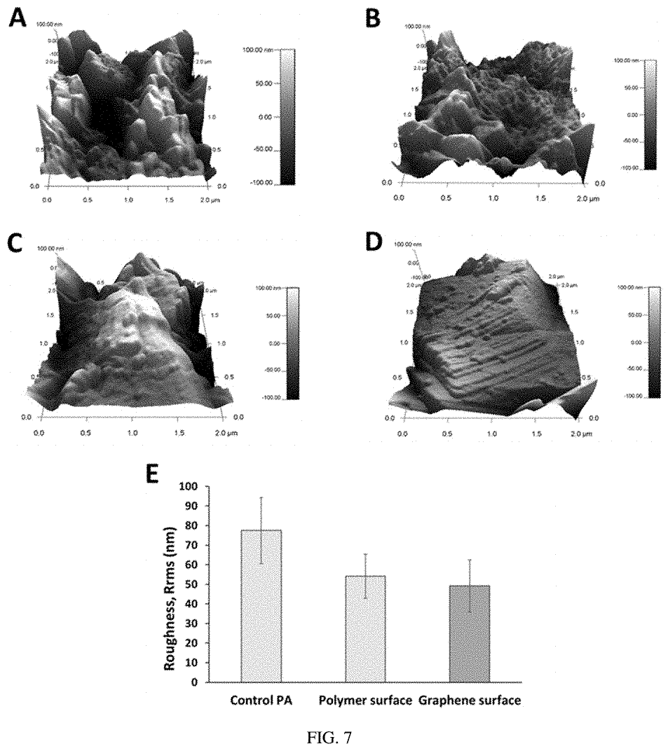

FIG. 7 shows AFM surface topology images where panel A is a control polyamide membrane; panel B is a graphene-polyamide composite polymer surface; panel C is a graphene-polyamide graphene surface; and panel D is a graphene-polyamide membrane graphene surface. Panel D shows a stripe structure that denote self-alignment of the graphene flakes.

Panel E in FIG. 7 is a graph showing a comparison of the roughness (Rrms) of the control polyamide membrane and of the polymer surface and the graphene surface of the graphene-polyamide composite membranes. All images were flattened to ensure the curvature of the substrate would not affect the height measurement.

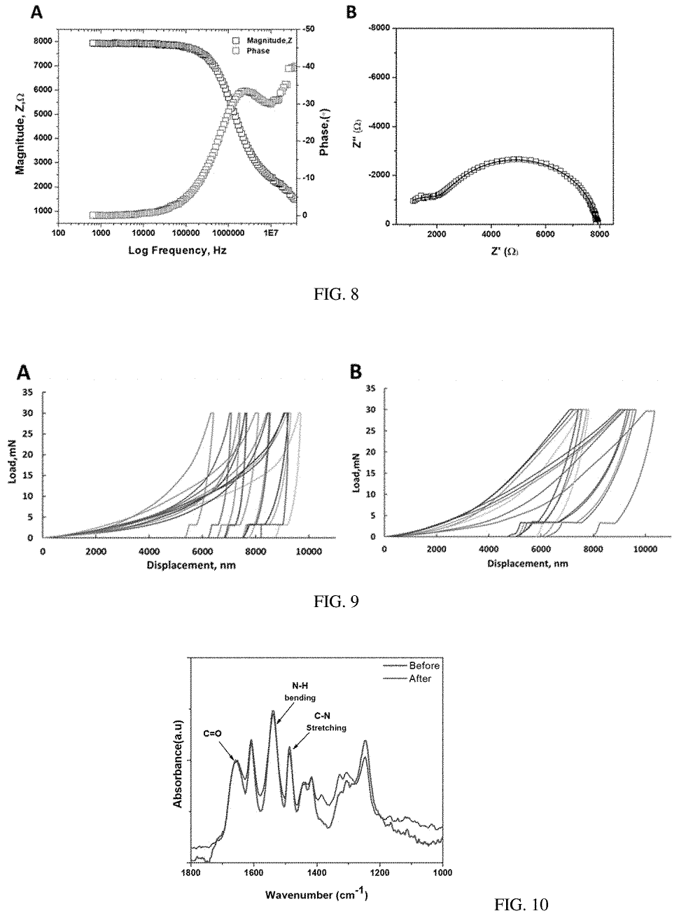

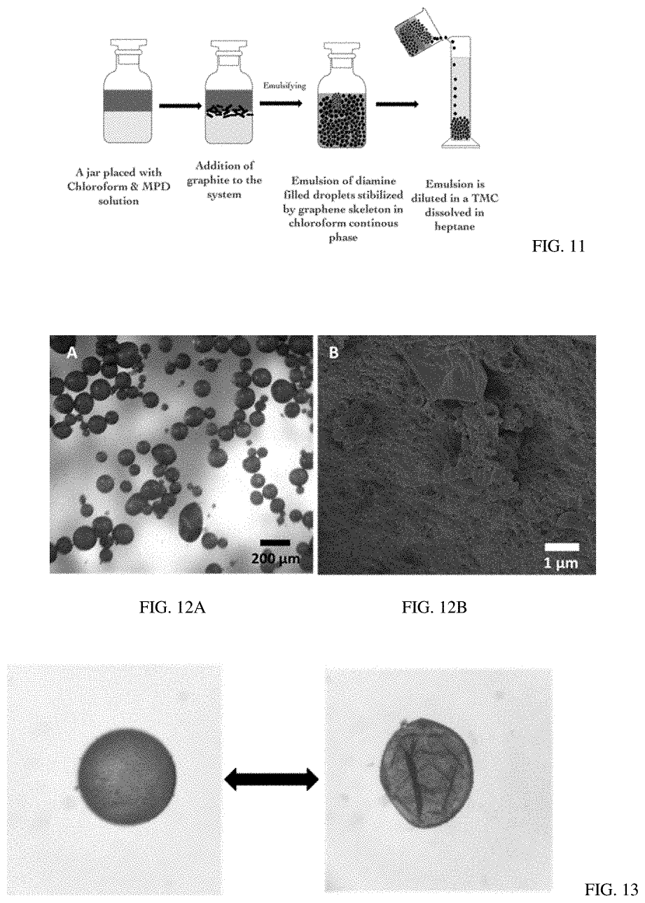

Electrical impedance analysis of a graphene-polyamide composite membrane sample to elucidate microstructural networks present in the membrane by impedance spectroscopy was performed. This technique measures the impedance of material at a varying frequency to elucidate the resistor, capacitor, or inductor behaviors of materials. FIG. 8 shows the measured impedance membrane using an AC signal with 1 Vrms amplitude in a 1-40 MHz frequency range. The magnitude of impedance (Z) remains constant, or a plateau in the range of 1-105 Hz, and drops afterward. The phase angle remains in the range of 0 to −90°. This behavior can be explained by the typical resister-capacitor (RC) of an electrical circuit. In the low-frequency range, up to 105 Hz impedance remains unchanged, implying the ohmic behavior of the graphene network where it acts as a resistor. When frequency further increases, the reactance of the system decreases, showing the capacitor dominance behavior. A Nyquist plot of an RC circuit typically would be semicircle as seen in FIG. 8 (right-hand panel).

Mechanical testing was performed to investigate the effect of in-situ generated reactive chlorine products on the membrane. Nanoindentation allows the evaluation of mechanical properties on a small volume of samples. Indentation on the composite membrane before and after the electrochemical reaction is shown as load-displacement, with L-D curves in FIG. 10. Material response as displacement under the applied force of 30 mN was measured. At 30 mN, both samples show a similar indentation depth, implying that mechanical properties are not much different. In ‘before’ samples at low indentation depth (less than 4 μm depth), the load increment is relatively smaller than the ‘after’ reaction sample. This is possible due to the presence of void spaces between graphene sheets. Indentation on less dense or void areas leads to sample compaction without increasing load. However, once the material is fully compact, the load increases drastically as seen in higher indentation depth in panel A of FIG. 9. The ‘after’ samples at the small load (less than 4 μm depth), show a higher slope or hardness (panel B of FIG. 10. Comparatively, the ‘before’ reaction sample undergoes plastic deformation at a lower load at the less dense region. Overall, at the large load of 30 mN, both samples show similar indentation depth and are scattered due to surface inhomogeneity.

FTIR analysis of the functional groups present in the membrane were performed before and after the electrochemical reaction through FTIR, as shown in FIG. 10. As can be seen from the results in FIG. 10, functional groups remained intact before and after reaction, implying that no chemical changes occurred in the membrane during the electrochemical processes.

### Example 2. Graphene-Polyamide Microparticles

### Synthesis of Graphene-Polyamide Microparticles

An aqueous solution was prepared by dissolving 2 g of m-phenylene diamine (MPD) and 11.6 g of NaCl in 100 ml of water. To 70 ml of this aqueous solution, 0.30 g of N24 graphite was added, along with 30 ml of chloroform. The mixture was shaken for 3 minutes in a bubble tea shaker, then diluted in additional heptane. This was then added to a graduated cylinder containing 100 ml of 0.2 w/v % trimesoyl chloride (TMC) and flipped several times, then allowed to stand overnight. The resultant polyamide beads (microparticles) were separated by gravity filtration to remove any excess TMC in heptane. Then, a 50:50 (volume or weight?) % ethanol:water solution was used to wash trace amount of organic solvent. The beads were then washed 4-5 times with deionized water.

### Desalination using Graphene-Polyamide Microparticles

FIG. 13 shows photographs of a graphene-polyamide microparticle illustrating the swelling (left panel) and shrinking (right panel) of a microparticle in response to an osmotic pressure difference. In particular, a single sphere (microparticle) full of water was placed on the stage of a stereomicroscope and allowed to empty while being recorded by a video camera. The figure is two screen capture images of the video. The picture on the left is the initial sphere full of water, and the picture on the right is the sphere after the water has diffused out, taking approximately 10 minutes.

As used herein, “a”, “an”, and “the” refer to both singular and plural referents unless the context clearly dictates otherwise. “Or” means “and/or”.

All ranges disclosed herein are inclusive of the endpoints, and the endpoints are independently combinable with each other. Each range disclosed herein constitutes a disclosure of any point or sub-range lying within the disclosed range. As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, insofar as such variations are appropriate in the invention described herein. Furthermore, it is also to be understood that the value to which the modifier “about” refers is itself specifically disclosed herein.

An amount of each of the components included in the nanostructure(s) as described herein may be determined through an appropriate analytical instrument and methods available to those of ordinary skill (e.g., an inductively coupled plasma atomic emission spectroscopy (ICP-AES), X-ray photoelectron spectroscopy (XPS), ion chromatography, Transmission electron microscopy energy-dispersive X-ray spectroscopy (TEM-EDS), or the like).

The terms “first,” “second,” and the like herein do not denote any order, quantity, or relative importance, but rather are used to distinguish one element from another.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

Chemical compounds are described using standard nomenclature. For example, any position not substituted by any indicated group is understood to have its valency filled by a bond as indicated, or a by hydrogen atom.

All methods described herein can be performed in any suitable order unless otherwise indicated herein or otherwise clearly contradicted by context. The use of any and all examples, or exemplary language (e.g., “such as”), is intended merely to better illustrate the invention and does not pose a limitation on the scope of the invention or any embodiments unless otherwise claimed.

Any combination or permutation of features, functions and/or embodiments as disclosed herein is envisioned. Additional advantageous features, functions and applications of the disclosed systems, methods and assemblies of the present disclosure will be apparent from the description which follows, particularly when read in conjunction with the appended figures.

All references listed in this disclosure are hereby incorporated by reference in their entireties.

While the invention has been described with reference to preferred embodiments, it will be understood by those skilled in the art that various changes may be made and equivalents may be substituted for the elements thereof without departing from the scope of the invention. In addition, many modifications may be made to adapt the teaching of the invention to particular use, application, manufacturing conditions, use conditions, composition, medium, size, and/or materials without departing from the essential scope and spirit of the invention. Therefore, it is intended that the invention is not limited to the exemplary embodiments and best mode contemplated for carrying out this invention as described herein. Since many modifications, variations, and changes in detail can be made to the described examples, it is intended that all matters in the preceding description and shown in the accompanying figures be interpreted as illustrative and not in a limiting sense.

What is claimed is:

1. A composite, comprising
graphene and an interfacially-polymerized polyamide,
wherein
the composite is in the form of a self-supporting membrane having a graphene side opposite to a polyamide side, or
the composite is in the form of a microparticle comprising a graphene core and a polyamide shell.

2. The composite of claim 1, comprising 10 to 90 weight percent of the graphene and 10 to 90 weight percent of the polyamide, each based on the total weight of the composite.

3. The composite of claim 1, wherein the membrane has a thickness from 10 to 5000 micrometers.

4. The composite of claim 1, wherein the microparticles have an average largest diameter of 0.5 to 800 micrometers, as determined by measurement of a sample by scanning electron microscopy.

5. A method of preparing the graphene-polyamide composite of claim 1 in the form of a membrane or microparticles, the method comprising:
forming a biphasic polymerizable mixture comprising an aqueous solvent, an organic solvent immiscible with the aqueous solvent, graphene, a polymerizable monomer composition; and
to form the membrane,
providing a single interface between the aqueous phase and the organic phase in the biphasic polymerizable mixture, and
allowing the polymerizable monomers to polymerize under conditions effective to form the membrane at the interface; or
to form the microparticles,
providing multiple interfaces between the aqueous phase and the organic phase in the biphasic polymerizable mixture; and
allowing the polymerizable monomers to polymerize under conditions effective to provide the graphene-polyamide composite microparticles.

6. The method of claim 5, wherein forming the biphasic polymerizable mixture comprises
combining the aqueous solvent to provide a graphite mixture; and
agitating the graphite mixture to convert the graphite to graphene.

7. The method of claim 5, wherein the polymerizable monomer composition comprises a polyamine compound and a polycarbonyl compound, each of which is aromatic.

8. The method of claim 7, wherein the polyamine compound is m-phenylenediamine and the polycarbonyl compound is 1,3,5-benzenetricarbony trichloride.

9. The method of claim 5, wherein the biphasic polymerizable composition further comprises an alkali metal salt, an alkaline earth metal, a main group metal salt, a transition metal salt, a lanthanide metal salt, or a combination thereof.

10. A method of water treatment, the method comprising:
providing the graphene-polyamide composite membrane of claim 1 for filtration by flow-through mode,
connecting the graphene-polyamide composite membrane to a current source,
supplying an effective amount of current to the membrane, and
passing water containing a source chemical for electrochemical oxidation and a solute for treatment over the membrane to obtain a filtrate separated from at least a portion of the solute for treatment.

11. The method of claim 10, wherein the source chemical for electrochemical oxidation is sodium chloride.

12. The method of claim 10, wherein the solute comprises a chemical, a mixture of chemicals, or a bacterium.

13. A method of desalinating water, the method comprising:
immersing the graphene-polyamide composite microparticles of claim 1 in an aqueous saline solution,
allowing the microparticles to selectively absorb water into their core and exclude one or more solutes,
isolating the microparticles from the saline solution, and
applying a pressure on the microparticles to release desalinated water.

14. The method of claim 13, wherein the microparticles are washed before a pressure is exerted on them to release desalinated water.

15. The method of claim 13, wherein the water for desalination is sea water.
